(19) United States
(12) Patent Application Publication
(10) Pub. No.: US 2010/0083322 A1
(43) Pub. Date: Apr. 1, 2010

(54) PROVIDING SELECTIVE VIDEO PROGRAM CONTENT AND ASSOCIATED LICENSE IN RESPONSE TO A PROMOTION TOKEN

(76) Inventor: Alan Rouse, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/240,399

(22) Filed: Sep. 29, 2008

(51) Int. Cl. H04N 7/173

(52) U.S. Cl. 725/93; 725/87

(57) ABSTRACT

A user initiates a request for program content to a cable services provider by providing a token authorizing the user to receive program content that otherwise would not be available. Typically, the token is provided to the user by a third party promoter. The token indicates a token code that the user provides to the cable provider, which authorizes the user to view a program. The promoter can offer tokens, which can be provided to the viewer in conjunction with purchasing a product, entering a contest, etc., as an incentive to purchase the product or enter the contest in order to receive the token. The cable service provider typically has, or can obtain the program content available for downloading to the viewer, and uses the information on the token to retrieve a digital license, which is provided to the viewer's set top box, allowing viewing of the program content.

### FIELD OF THE INVENTION

The present disclosure pertains to fulfilling requests for video programs from subscribers of a cable system wherein the subscribers receive a token providing for limited entitlement for viewing the program content.

### BACKGROUND OF THE INVENTION

Presently, cable service providers offer various services to their cable subscribers, which include the ability for subscribers to request viewing specific programs at the convenience of the viewer. This capability is generically referred to as “video on demand” (“VOD”) and allows the user to select the content of what they desire to view and determine the time of when they may view it. Presently, cable service providers maintain a library of such programs, and present the viewer with a list of titles, and allow the viewer to select the desired program. This capability may be referred to in various forms, such as movies on demand, content on demand, etc. As used herein, “VOD” refers to the broad capability, and is not limited to any particular form of program content.

It is quite common for the programs available to subscribers in a cable system via VOD to be movie programs, which were originally distributed in movie theaters. Typically, after the “run” of the program in the theaters, the movie is released on DVDs and sold through various distribution and retail outlets. Then, once profits from this distribution channel have been maximized, the program is then made available to subscribers of premium channels (e.g., Cinemax™). After this distribution channel has been maximized, the program typically is made available over non-premium channels or network channel. At this last level of distribution, the program value is typically at its lowest, and it represents the least exclusive distribution channel. Further, at this point those viewers willing to pay a premium have previously seen the movie.

The revenue from the program distribution at the first level, via movie theaters, is typically maximized by promoting the movie in conjunction with a third party entity that obtains semi-exclusive co-marketing rights. For example, a fast food chain may have exclusive rights to advertise their product (e.g., hamburgers, pizza, etc.) with an action figure based on the movie. In this manner, promotion by the fast food chain benefits the movie producer by increasing awareness of the movie, which is likely to increase attendance at movie theaters.

At a high level, this distribution chain has evolved over time taking into account changes in technology allowing new distribution opportunities, new profit maximization techniques, and other factors. One such other factor influencing the distribution chain takes into account the profit loss that may occur due to piracy—e.g., the availability illegal recordings of the program may be illegally distributed and sold, which in turn reduces the value of the program in a given legitimate distribution channel and may hasten the movement to the next distribution channel.

There is also an advantage with respect to profit maximization to maintain control of the program as it is being distributed in a given channel. For example, while the movie is distributed in movies theaters, the movie typically is not made available via other channels. Doing so would reduce the profits from the movie distribution channel because the other channels, such as making the movie available via premium or cable channels are typically marketed at a lower price point, in order to appeal to those less likely to pay the premium in the movie theaters.

In some instances it would be desirable to make programs available to subscribers in a cable system earlier than as described in the above sequence of distribution channels. For example, making a relatively new program available to a select few subscribers willing to pay a premium would allow the producer to retain the exclusivity of the program and establish a co-marketing agreement with a third party promoter. Alternatively, the movie producer may desire to promote the movie by allowing a select number of viewers to be able to view the program via a cable system. However, the movie producer could not effectively control who, or how many individuals could view the program and controlling piracy was difficult. Consequently, cable service providers could only become involved in a program's distribution after the movie theater and DVD distribution channels were completed.

Thus, there is a need for systems and methods allowing program producers to control distribution of programs to viewers on a cable system to a greater degree and thereby allow cable service providers to engage in program promotions with third parties earlier in the distribution process.

### BRIEF DESCRIPTION OF THE SEVERAL VIEWS OF THE DRAWING(S)

Reference will now be made to the accompanying drawings, which are not necessarily drawn to scale, and wherein:

FIG. 1 discloses one embodiment of a system according to the principles of the present invention for fulfilling a subscriber's request for content.

FIG. 2 discloses one embodiment of a high level overview of the method according to the principles of the present invention for fulfilling a subscriber's request for content.

FIG. 3 discloses one embodiment of a high level overview of the interaction between the viewer and set top box.

FIG. 4 discloses one embodiment of a high level overview of the process performed by the set top box.

FIG. 5 discloses one embodiment of a high level overview of the process performed by the cable service provider.

FIG. 6 discloses one embodiment of a high level overview of the process performed by the license provider.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

As used herein, “program” typically refers to a digital video asset that can be of various formats, e.g., movies, documentaries, television serial programs, sports programs, news programs, etc. Although described as a video asset, it should be understood that the program would also encompass any accompanying audio information encoded within it. Although described primarily in the context of a movies initially available in movie theaters, it is not intended to be limited to only movies. In other applications, the program can be an audio only program, such as music releases or a short video promotion for a movie, called a “movie trailer.” Thus, the preferred embodiment for illustration the principles of the present invention is described in reference to “movies,” but it is not limited thereto.

Further, although described in the context of a cable system (e.g., “cable service provider”), the principles of the present invention apply to other technologies, such as IPTV, satellite television delivery, Internet based technologies, and other forms of video delivery technology.

Program producers attempt to maximize revenue from a program, such as a movie, using several well established marketing techniques. One of these involves a sequence of marketing channels, which typically starts with an exclusive marketing channel (such as movie theaters), and then continues to less exclusive marketing channel (DVD sales or rental, movie-on-demand, etc). Although there is no set rule, typically the distribution channels involve in order: movie theaters, DVD distribution (sales or rental), premium channel distribution, and then non-premium or network distribution. Each subsequent distribution channel typically occurs at a certain amount of time after the previous distribution channel, and thus the price that can be charged diminishes over time. Thus, because cable service operators are at the end of the distribution channel process, and the exclusivity of the product is at a minimum, the price that can be charged is limited. In many instances, the program is bundled into a service offering (as for a premium channel), and there is little opportunity for the cable service provider to receive additional revenue relative to the preceding distribution channels.

Movie producers also maximize revenue by establishing co-marketing agreements with third party promoters. Typically, the third party promoters involve nationwide retailers or manufacturers that offer ‘tie-ins’ between their product and the movie. For example, a movie may be based on an action figure, and a fast food chain may offer a free plastic toy with the purchase of a meal wherein the toy is based on the action figure appearing in the movie. In such instances, the movie producer and the fast food chain entered into the appropriate agreement allowing use of the intellectual property of the movie producer to market the hamburger chain's goods.

Such co-marketing agreements typically have not included cable service providers (“CSPs”) because CSP were already involved, but only indirectly at a lower point in the distribution process. Specifically, only once the program was offered on a premium channel could the CSP then become involved. Further, at that point, the CSP's involvement was only as a provider or conduit for the premium channel provider. While the CSP would become more directly involved with the movie distribution if the CSP offered the program as a movie on demand, but typically occurs at the end of the distribution process and the value of the program is minimized relative to the prior forms of distribution. Specifically, the price that could be charged for viewing the program would typically be much less, because the program had been released and available in the other distribution channels for some time.

However, the ability to control and limit the viewing of programs to a subscriber in a cable distribution network is now possible as defined herein which is based in part on a system that provides for obtaining real time licenses for viewing programs as described in U.S. patent application Ser. No. 12/140,591, entitled Digital Rights Management Licensing Over Third Party Networks, filed on Jun. 17, 2008, the contents of which is wholly incorporated in the present disclosure. By limiting the distribution of digital rights to select subscriber's of a cable system, only those select viewers can view the program, and based on terms dictated by the license provider. Thus, it is possible now to incorporate CSPs in the earlier stages of the program marketing distribution. The movie producer, who typically owns the licensing rights, is now able to incorporate CSPs earlier in the distribution process to maximize revenue or to promote a movie by controlling its availability to CSP subscribers. Further, the movie producer can also involve CSPs in co-marketing programs with third party promoters without sacrificing exclusivity or relinquishing control of the product.

### General Overview

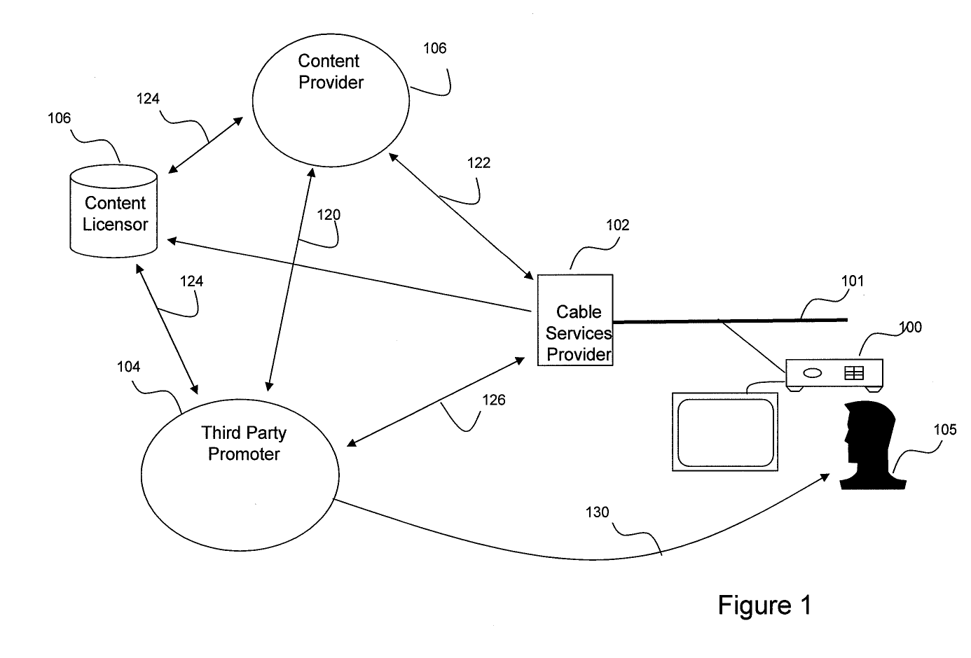

The basic entities involved are shown in FIG. 1. The initial entities focused on are the Content Provider 106 and the Third Party Promoter 104. The Content Provider is a broad term that means the entity having rights to the content. In the example described herein, one embodiment is the movie producer, who has produced a movie and is seeking to maximize profits. However, as will be seen, the Content Provider can be a number of entities that do not fit the characterization of a movie producer, and who main business is not entertainment, but for example, retail, education, etc. Further, the Content Provider does not have to intimately associated with the nature of the program content. In other words, the Content Provider's business or purpose is not necessarily associated with the type of program being distributed.

Consequently, the “Content Provider” does not necessarily have to be the program producer, but the entity having the rights to control distribution of the program. Thus, an entity owning a program, even though produced by another, would be the “content provider.” The Content Producer could be also a distribution source as opposed to the producer. Similarly, having an exclusive license to distribute the program (as opposed to owning the right completely) could allow that entity to be viewed as the Content Provider. Further, other arrangements may be involved where the program owner relies on a third party acting as an agent for distributing the program and all such arrangements are still within the scope of the present invention.

Further, the program content provided by the Content Provider is not limited to movies, but could be any video or musical digital asset. Thus, documentaries, sports programs, archive footage, movie trailers, etc. are also intended to be within the scope of the present invention. Those skilled in the art will readily appreciate that a variety of program contents can be promoted according to the principles of the present invention.

The Content Provider 106 will typically arrange with a Third Party Promoter 104 to engage in promotion of the program content. The Third Party Promoter can be an advertisement agency or marketing entity who business is to promote a product, and is in fact promoting the program itself. In other embodiments, the Third Party Promoter is a provider of goods or services in its own right, and is engaging in co-marketing the program content with its products. Examples of Third Party Promoters typically include: national retailers, such as home improvement stores, fast food, and service providers (including cable services providers), and manufacturers, such as automobile manufacturers, computer manufacturers, etc. In short, the Third Party Promoter can be diverse.

The subject matter of the program content will often suggest a potential Third Party Promoter. Thus, a movie about future technology may motivate a computer manufacturer to engage in co-marketing of the program, whereas other movies, such as those featuring automobiles, may involve an automobile manufacturer co-marketing the movie. Because of the broad possibilities of subject matter involved in a program, a variety of Third Party Promoters may be involved.

The Content Provider and Third Party Promoter will reach agreement as to the nature of the co-marketing or promotional program. Turning to FIG. 1, this arrangement is represented by line 120, which represents the communication and agreements reached by the two entities. The agreement will include plans for manufacturing or distributing a “token” for the target consumer. The “token” can take on various forms, but typically involves something capable of bearing indicia or print to convey information. The item bearing the token code could be part of the consumer good purchased by a consumer of the third-party-promoter's goods (such as a bottle cap), or it could be an item (such as a card) whose purpose is primarily to indicate the token code. For example, in the case of the soda bottle cap, this item is inherently part of the goods purchased by the consumer. If the Third Party Promoter is a service provider, it may be necessary to instead have cards printed up bearing the token or use a receipt, which is provided to the purchaser.

In other embodiments, the viewer could possess the token code in stored digital form in a USB thumb drive, or on a CD, or on any other type of removable storage device supported by the Third Party Promoter and the set top box, or on any storage device accessible over a network from the set top box. In the case of a removable storage device, the device itself might be provided by the Third Party Promoter, or alternately it might be owned by the viewer and used to receive the token code from the Third Party Promoter. In such cases the physical device is the token, and the token code is not in a human readable form, but a machine readable form. The viewer would attach, plug-in, or otherwise connect the token into the set top box by attaching or inserting the storage device into an appropriate port or drive on the set top box, or by using navigation functions on the set top box to select the token from storage over a network. Although physical connection is illustrated, it is possible that wireless communication of the token code can occur as well.

In this context, the token's purpose is to convey a code, called the token code, which entitles the user to see the promoted program. Typically, the cable subscriber provides the token code to their cable service provider to view the program. The code is essentially an authorization or entitle code. The token code can be manifested in various ways, including using values printed in newspapers, advertising inserts to magazines. Further, the token value could be based on a serial number or UPC code of the product. Thus, instructions could be provided to the consumer when purchasing a product indicating that the product serial number (or some other code associated with the product) can be entered as a token code. Thus, it is not always necessary to produce a separate physical token to indicate the token code, but this is always an option.

One embodiment illustrates these concepts. A nationwide bottler of soft drinks is engaged in promoting a major movie production. The soft drink bottler advertises a contest where purchase of its product may provide the purchaser with a token code printed on the inside of the screw cap. The inside of the screw cap will indicate the code printed in the cap. As with many contests, there are typically different levels of prizes provided. For example, most of the screw caps will indicate the purchaser has not won anything and encourage them to try again by purchasing another product item. Other purchasers may receive a message indicating they can view a special movie trailer (not the movie itself) which represents a “sneak-preview” of the movie by using the token code. Other purchasers, typically more limited segment, will receive a screw cap indicating they have won a free viewing of the movie via their cable system by using the indicated token code.

In other embodiments, the token code can be indicated verbally, such as via an interactive voice response system, or presented to the user via a computer. Thus, in this case there is no separate physical token distributed by the promoter that conveys the token code. However, in many instances, the Third Party Promoter will use a physical token to indicate the token code.

As will be discussed shortly, the token code is entered by the purchaser to obtain authorization to view the program content. This process is typically referred to as token redemption or redeeming the token. However, it should be clear that a physical token is not always required, and one could refer to the process as redeeming the token code. However, the distinction between the two is usually moot.

In this manner, the Third Party Promoter encourages purchases of its products by a ‘tie-in’ with the promoted program content. The promotion of the program content can be limited as desired by the Third Party Promoter. Specifically, the Third Party Promoter knows how many token codes are distributed, and their value (e.g., what program the code entitles the viewer to see). Further, the Content Provider also can control the redemption of the tokens via the token code. For example, the Content Provider can limit the duration of the token codes can be redeemed during a certain time frame, or may contract with the Third Party Promoter to limit the number of token codes distributed or how times any given token can be used. Thus, tokens can be limited in time to viewing the pre-view movie trailers before the movie is introduced in theaters, and can ensure that a winning token for viewing the movie is limited in time and can be used only once. In other embodiments, each token could bear a token code, most of which allow viewing of the movie trailer, but a select few which allow viewing of the movie itself. In this manner, there is flexibility to allow both the Third Party Promoter and the Content Provider to control the ability of tokens to be redeemed. In some embodiments, this functionality could be performed by other entities, such as the Licensor or the Cable Services Provider.

The Cable Service Provider 102 shown in FIG. 1 is an integral part of the promotion, because redemption of the token always involves the CSP. Again, the “CSP” is not necessarily limited to delivering programs via cable technology, but can encompass other technologies as indicated previously. The CSP is inherently involved, because it distributes the program content to the viewer who has redeemed the token. Typically, the Content Provider and/or Third Party Promoter coordinate with the CSP to provide the appropriate program content in response (or in anticipation of) the user redeeming the token code. This is indicated by line 122.

The Content Provider typically will provide an encrypted copy of the program to the CSP provider. The CSP will store this copy locally, and download it to the subscriber redeeming the token as required. In other embodiments, the Content Provider will provide the program on-demand to the CSP as needed. However, because it is anticipated that the CSP will be providing the program to at least some of its subscribers, providing the content to CSP prior to fulfilling an initial request may be more efficient. Because the content will be encrypted, there is more security offered to the Content Provider than if the content were provided without encryption. Thus, the Content Provider is more likely to allow the CSP to store the content, knowing that it cannot be easily decrypted and therefore compromise the value of the program.

The Content Provider also reaches an agreement with the Content Licensor 106, as indicated via line 124. The Content Licensor (also referred to as Licensor or Licensing entity) acts on the behalf of the Content Provider to manage and assign the digital rights licenses, a process sometimes referred to as digital rights management (“DRM”). The Content Licensor receives requests from various CSPs for licenses and provides them as necessary. The licenses are decryption keys allowing decryption of the program. Hence, the licenses are also referred to as “descryption keys” or “keys.” This process also involves accounting for the use of the licenses, which may have various restrictions associated with them.

The accounting for license use may be used in rendering any statements, bills, or usage summaries. Thus, the Content Licensor may bill the CSP for providing the licenses. Because Content Providers may not have the expertise for allocating and managing digital decryption keys and accounting for their use, or because there may not be sufficient economies of scale to justify a Content Provider implementing the Content Licensor functionality, the Content Licensor may be a separate entity from the Content Provider and is shown as a separate entity in FIG. 1. However, it is quite possible in other embodiments to combine the functionality of the Content Provider and the Content Licensor, so that these functions are performed by the same entity. Further details are found in the aforementioned patent application.

There is also required to be an agreement in place between the Third Party Promoter 104 and the Content Licensor 104, as shown by lines 124. One aspect of this agreement involves the values of the token codes that are used by the Third Party Promoter and controls associated with their use. As previously indicated, the token codes are printed on tokens and distributed by the Third Party Promoter to be made available in some manner to the consumer/viewer 105. The codes redeemed by the viewer have to be recognized as valid codes, and hence the coordination between the Third Party Promoter and the Content Licensor as to what codes are valid, what programs they can be used to redeem, how long are they valid, etc.

Typically, the Content Licensor will maintain a list of the set of token codes used by the Third Party Promoter, along with various restrictions associated with the codes. The Content Licensor may have agreement with a number of Third Party Promoters, hence it is necessary that the codes are distinct. This is simplified in that the token codes typically have a limited life, e.g., they are only valid for the duration of the promotion. Thus, if an upcoming movie is being promoted, the token codes are typically valid during a limited time window, and expire after a fixed time, e.g., six months. While the codes are typically not reassigned immediately, they can be after another waiting time period, e.g., 2 years. These values are only illustrative, and may be shortened or lengthened as needed.

The Content Licensor may also know which codes from any given Third Party Promoter can be redeemed on which CSPs. Thus, the Third Party Promoter may have agreements with various CSPs, as indicated via lines 126. It may not be necessary, as will be described below, for the CSP to necessarily have an agreement with both the Third Party Promoter and the Content Provider. However, at least the Content Licensor may require information as to which token codes can be used with which CSPs.

Once the agreements have been established, the promotion of the program can occur. The Third Party Promoter will typically engage various other entities for the actual design, manufacturing, printing, and distribution of the tokens. The distribution of tokens to the viewer is illustrated via line 130, which although is exemplary because the distribution of tokens to the viewer occurs via many different channels. In practice, other entities, such as retail stores are involved, but are not shown in FIG. 1.

The process for the viewer to redeem the token involves the user interacting with a television set, the set top box, and the remote control. Typically, the CSP provides a mechanism to prompt the user to enter the token code by downloading an applet or application program to the set top box. This program configures the set top box to prompt the user to enter the code, which the set top box then conveys to the CSP headend. There, the CSP will use the token code to obtain a license from the Licensor to view the particular program content. After authenticating the token code and providing other checks, the program is then downloaded to the set top box for viewing. This process may utilize the procedures described in the aforementioned

### Digital Rights Management Licensing Over Third Party Networks.

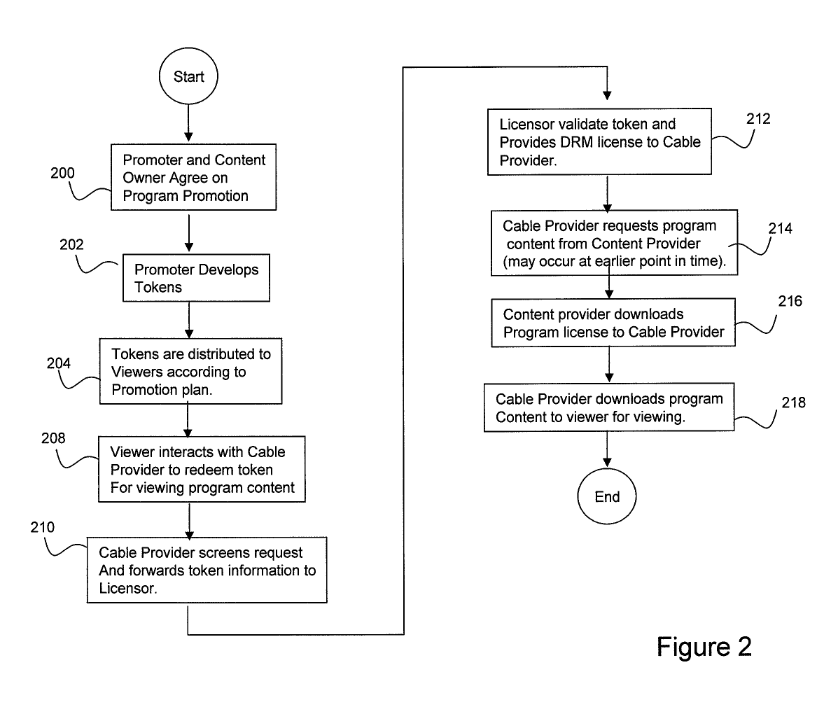

The overall description of this process is disclosed, in an abbreviated form, in FIG. 2. In FIG. 2, the process begins in step 200 when the promoter and content owner agree on a particular program promotion. These agreements are worked out in conjunction with the CSP and licensor. At step 202, the promoter develops the tokens, which will bear the token codes for the viewers. These are typically defined for use during a certain time period coinciding with the promotion. At step 204, the program promotion begins and the tokens are distributed to the viewers by the Third Party Promoter. At step 208, the viewer interacts with the CSP to redeem the token by entering the token code into the set top box. As described below, this is accomplished using a downloaded applet to the set top box which provides the appropriate human-machine interface for redeeming the token. The next step, 210, involves the CSP optionally screening the request. It may be that the subscriber has not been authorized for any such promotions for various reasons (e.g., their account is past due, or such procedures are prohibited for this subscriber). The CSP sends the token code to the Licensor in order to obtain the digital rights—e.g., the license in the form of keys to decrypt the program. At step 212 the licensor validates the token code, as well as potentially the CSP that originated the request, and provides the digital rights management license to the CSP. The next step 214 is optional and involves the CSP requesting the content from the Content Provider. Typically, there will be more than one subscriber in the system requesting the program, and the CSP may have previously downloaded and stored the program in local storage. Or, the CSP may have obtained a copy of the program prior to the start of the promotion for another subscriber and stored it locally. Thus, the program contents does not necessarily have to be downloaded at the same time the subscriber redeems the token. The next steps 216 and 218 involve the CSP downloading the program content and the license to the set top box allowing the viewer to view the program. It is possible to perform these steps in different order. For example, it is possible to download the program content from the CSP to each subscriber's the set top box during off hours in anticipation that a subscriber will redeem a token. If the subscriber redeems the token, then only the license needs to be sent to the viewer and there is no delay in downloading the program to the set top box. If the subscriber does not redeem the token, the set top box can be instructed to erase the encrypted program automatically after a defined time period. Whether this option occurs may depend on various factors and may be defined by the agreements between the CSP, Content Provider, and Third Party Promoter.

User's Perspective

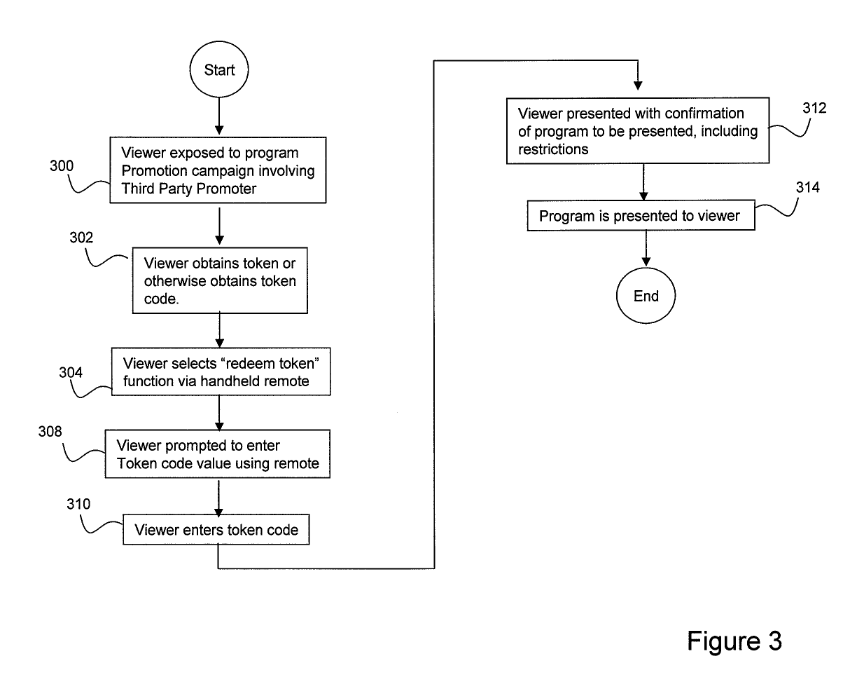

FIG. 3 discloses the user's perspective of obtaining and redeeming a token. In step 300, the user is exposed via traditional marketing channels to the promotional campaign. The promotion can be communicated via various media, including print, television ads, internet ads, etc. The promotion may be contingent on entering a contest, purchasing a product, or otherwise requesting a token. In some embodiments, the token itself may be an existing item on which the token code is printed. For example, a receipt or an item's packaging may have the token code printed on it, or a separate card may be printed bearing the token code and given to the viewer. In other embodiments, the token code can be communicated to the viewer via audio (as in calling into an automated voice response system) or by receiving an email message, or presenting information using an Internet window indicating the token code. In step 302, the user obtains the token bearing the token code or otherwise obtains the token code from the Third Party Promoter. Typically, the viewer is made aware of certain restrictions associated with the promotion, such as a time window during which the token can be used.

In step 304, the viewer begins the process of redeeming the token. This typically occurs by the user interacting with the television via the set top box. The CSP will have provided in the set top box an application program which interacts with the user and provides the necessary human-machine interface. This interface may manifest itself by defining a selection option labeled as “redeem token” or otherwise indicating to the user a function for redeeming the token to view a program. The user typically makes the selection by using the hand held remote and viewing the indicia presented to the user on the television. The indicia is typically locally generated by the set top box, as opposed to presenting the contents of a channel.

In step 310, the viewer enters the token by pressing the buttons on the remote. Typically, the token code is a numerical value, but in other systems it can be alphanumeric (particularly, where there is a suitable input device allowing indication of such).

After entering the code, the system will process the token code. FIG. 3 presumes that the code is valid, and other that other tests (e.g., if defined by the CSP) indicate that the token can be redeemed. Various error handling aspects can be readily defined in the applet by one skilled in the art to provide appropriate feedback to the viewer if the token cannot be redeemed. These would include procedures for informing the user that the code has been already used, that the code has expired, the service is not available to this subscriber, or other technical difficulties precluding providing the program to the viewer. The system will inform the viewer via images on the television set of certain restrictions. For example, restrictions may include:
a. the number of times the program can be viewed;
b. playback functions (e.g., pause, rewind, fast forward) that the user can invoke;
c. the ending time/date of the promotion; or
d. the ability to record or otherwise download the program for future viewing or on another device.
   These are not intended to be exhaustive limitations, but exemplary.

Other embodiments may require the user to agree to such terms by interacting with the remote control in a certain manner (e.g., the user may acknowledge the terms). Other embodiments may also communicate the restrictions in machine readable form to the set top box to enforce the restrictions. Once the preliminary restrictions are conveyed to the user, the program viewing may begin at step 314. Once the viewing is complete, the token redemption process is completed.

### Set Top Box Operation

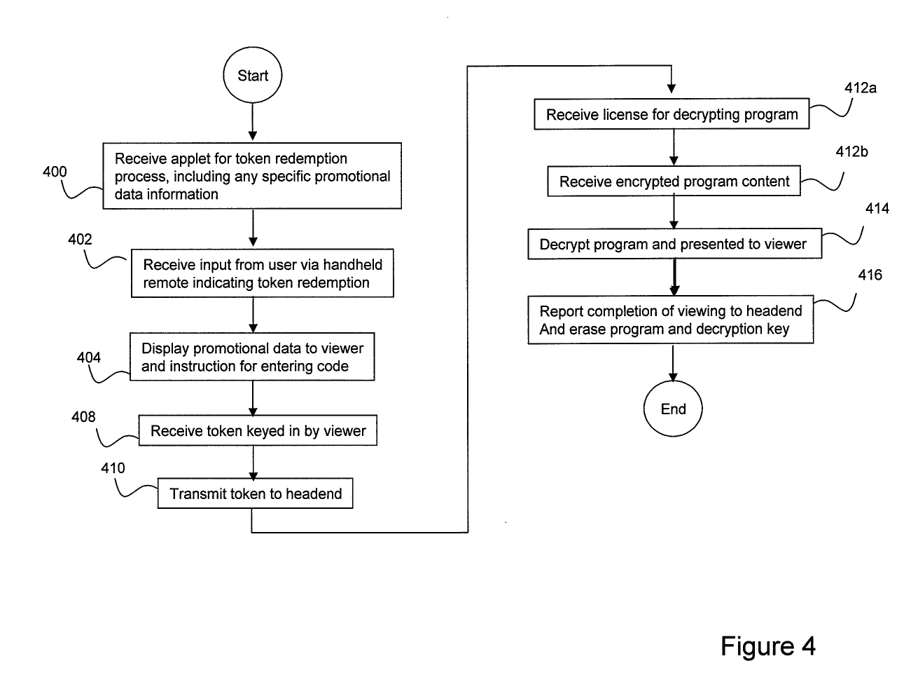

The set top box operation is disclosed in FIG. 4. The process begins in step 400 with the CSP cable headend downloading an applet to the set top box to process the user input. The procedures for downloading software to a set top box (called “carouselling”) are well known in the art and can be used. In other embodiments, such as in IPTV applications, other well known protocols, such as Internet type protocols can be used to transfer software. Typically, the applications are downloaded in advance of the promotion, and it is possible to define a generic application which can be used for any promotion, as well as an application that can receive promotion specific data, thereby allowing the human-machine interface to be customized for a particular promotion. Thus, it is possible to display to the user prompts specific to the promotion. This would allow promotion specific instructions or terms to be communicated to the viewer.

After the applet is installed in the set top box, the user will indicate via the handheld remote that token redemption is desired. This may be accomplished by tuning to a defined channel which has various service options. Typically, CSPs reserve a channel in the system for such service options. One service specific function can be defined as “token redemption” or some other name indicating this function. This is shown at step 402.

Upon detecting the function request, at step 404 the set top box displays on the television the appropriate instructional or other promotional specific information. Typically, the user would be instructed to enter the token code and where it can be found. For example, if the token was printed on a receipt, the instructions presented to the view on the television could provide a simulated receipt and an arrow indicating as to where on the receipt the token code is printed. The user would then enter the information using the numerical keypad on the remote. Such techniques are well known to one skilled in the art for interacting with the user via cable system set top boxes.

After receiving the token, and acknowledging receipt, the set top box in step 408 transmits the token code to the headend. Any number of well known protocols can be used. The set top box then waits for a response. The CSP may perform various screening tests at this point, but they are transparent to the set top box.

Presuming a response is received in a timely manner, the result is that in step 412a that the license, which is essentially a decryption key, will be provided to the set top box for decrypting the program. The program content is then followed in step 412b. In other embodiments, the program content could be sent to the set top box before the license is sent, or even sent to the set top box in anticipation of the user requesting redemption of the key. The transmission of the program content may take a while, such that the user may be information by the set top box to check later as to when viewing can be initiated. This depends on the size of the file of the program, the capacity of the cable network, and other factors. If a delay is expected, the set top box may inform the user that they can check in later regarding the status or an estimated time before viewing can commence.

In step 414, once the program content is received and the license (decryption key) is also received, the set top box can begin decrypting the video and streaming it to the user's television set. This may occur in real time, or may occur at a later time when the user indicates that they are ready to view the program. There may be a time limit by which the user has to actually view the program.

Step 416 is not required, but it is desirable for the set top box to report to the headend whether the program was actually viewed, or how much of it was viewed. This information may be useful for various applications. For example, a program may be test-marketed, and if there is a high level of incompletion of viewing, it may signify that the program content was not interesting to the viewers. In addition, it is desirable that the set top box erase the program and the decryption key for security reasons, as well as to avoid unnecessary storage of programs on the hard disk drive in the set top box. In other embodiments, the set top box could be programmed to request the viewer to rate or otherwise provide opinions on the program content. The user feedback can be transmitted to the headend and used to analyze the acceptability of the program content.

### Cable Services Provider Operation

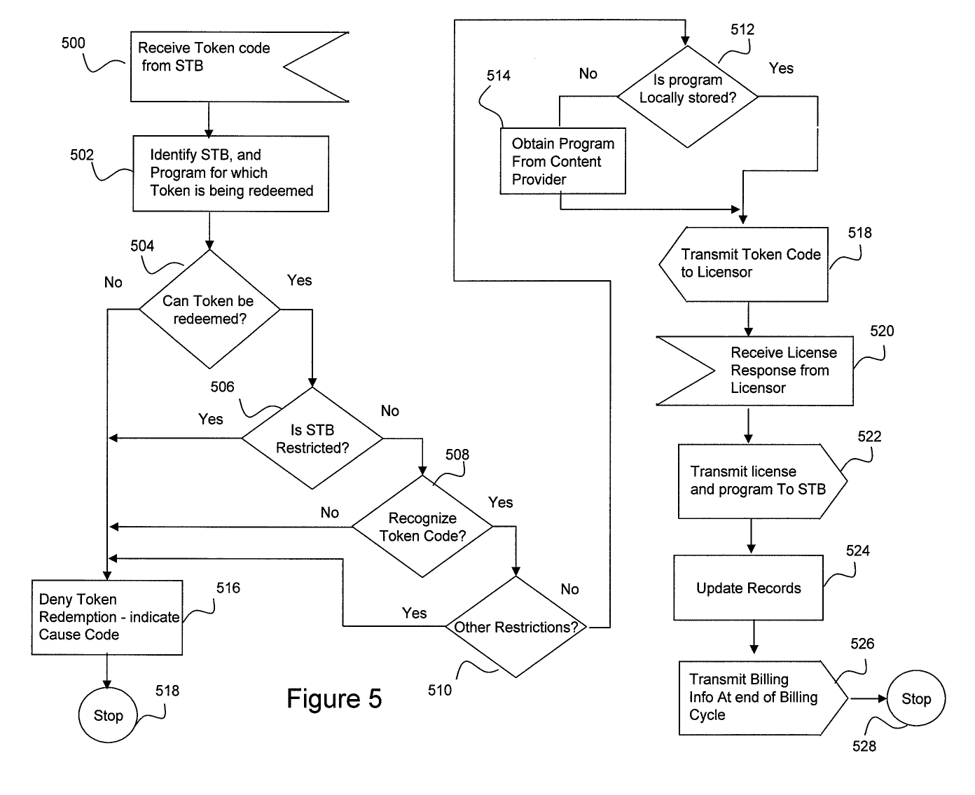

The process performed by the CSP is shown in FIG. 5. This begins at step 500 when the cable headend in the CSP receives a request for redeeming the token code from the set top box (“STB”). The format of the message can be in various formats. The request for redeeming the token can be implicit by the presence of the token code, or made explicitly in the message(s).

The CSP then identifies in step 502 the particular STB initiating the request, which is necessary for performing the various screening functions, and for other purposes. The request may indicate the particular program, but in other embodiments, only the token value will be received. If the program itself is not explicitly identified in the request, the CSP may have a table which maps the token code to identify a particular program, or the CSP can request another entity to identify the particular program based on the token code. Or, the CSP can convey the token code to the Licensor, and allow the Licensor to determine which program it is associated with. However, the

In step 504, the CSP begins a series of screening and/or testing functions to determine if the request can be processed. These tests can vary as to the particular function performed, and other embodiments may augment or replace the tests as indicated herein with other functions. The first test is to determine if the token can be redeemed. There may be various reasons why it cannot, including that there are no active redemption programs in existence, technical difficulties, etc. Step 506 is another test which screens the STB to determine if it is authorized to initiate the request. The STB itself may be barred from receiving such programs for various reasons. The account to which the STB is associated with may be delinquent, or the user previously indicated to the CSP that the subject matter of the program not be presented (e.g., no programs that are R rated should ever be accessed).

In step 508, the token code may be tested to determine whether it is recognized. The CSP may maintain a list of tokens which it compares the incoming token code against. If so, the CSP may limit the number of times the token code can be redeemed (e.g., one or a limited number of times, and/or during certain time windows). This list may not be maintained by the CSP, but may be maintained by a third party. Finally, step 510 recognizes that there may be other additional restrictions as well. As is evident, the criteria and nature of each of these tests can vary and be defined differently in various embodiments.

Once the screening and/or testing steps indicate that the token code can be processed, the CSP determines whether the program is locally stored in step 512. As indicated previously, the CSP may receive a copy of the program in encrypted form which is stored locally or otherwise readily available to the CSP. The CSP may have previously fulfilled a request which necessitated obtaining an initial copy, and then stored the copy locally in anticipation of subsequent requests. Thus, in step 512 the determination is made whether the program is readily available, and if not, then in step 514, the program content is obtained.

The next step is shown in step 518 where the CSP transmits the token code to the Licensor. The Licensor responds in step 520 with a decryption key, which is the license, allowing decryption of the program. The CSP in step 522 then transmits the license and the program to the STB. At this point, the STP can then interact with the viewer allowing the program to be viewed.

The CSP can perform these steps in a different order, as one skilled in the art would recognize. For example, the CSP could download the encrypted movie to the STB sooner in the process, and then download the license to the STB. The provision of the license will typically indicate various control parameters to the STB. For example, control codes can provide indications as to how long the program can stored before viewing, whether the program can be downloaded to a portable viewing device, how many times it can be viewed, etc.

The CSP typically updates various internal records in a file stored in a database as shown in step 524. This reflects what occurred—e.g., what the token code was provided by the viewer, what program was downloaded, the time/date of the request and the download, etc. This allows the CSP to provide an accounting for which tokens were redeemed, when, and by whom. This information may be shared with the Content Provider or the Third Party Promoter allowing the effectiveness of the promotion campaign to be analyzed.

Step 526 represents an optional billing step, wherein the CSP transmits billing related information to its billing systems. The billing information reflects the transaction to the user's account, where separate business rules of the CSP determine whether the viewer is actually charged for the program. In many embodiments, the Third Party Promoter provides the token codes allowing the user to view the program at no charge from the CSP. However, there are other applications where a charge will be levied against the account. For example, the token may entitle the viewer to receive a discount from the regular rate. Or, the token may be considered as allowing the viewer to view the program at a premium rate, wherein the token serves to control who is allowed to purchase the program. In other embodiments, the token may authorize the viewer to access proprietary information, for which the cost is borne by the viewer. Specific examples of the above may include offering the viewer educational programs, continuing education programs, etc, which are offered to certain viewers on a pay-as-you go basis, but which are limited to only those viewers with the tokens. Thus, there are a variety of possible billing arrangements that the CSP can structure with the viewer in conjunction with the Content Provider and the Third Party Promoter.

Similarly, there are various arrangements for which reimbursement of costs can occur between the Content Provider, CSP, and Third Party Promoter as considered in greater detail below.

### Licensor Operation

This section describes the operation of the Licensor, which is the entity providing the licenses (e.g., the digital keys or decryption keys). Although this section uses the term “Licensor”, in this context it should be broadly construed as the entity to which the CSP sends the request to, and receives the license from. This can also be referred to as the “licensing server” which refers to the equipment operated by the Licensor. The CSP may send the request for the license to any entity, including the Third Party Promoter, or the Content Provider who in turn, may forward the request to the Licensor, which provides the license. In other embodiments, the Third Party Promoter or the Content Provider can function as the Licensor (by implementing the licensing server). Thus, from the CSP's perspective, the entity from which it send the request to, and receives the license in response from, is the Licensor. However, the entity could actually be an agent for the actual Licensor. Thus, for simplicity, it is assumed that the CSP 102 of FIG. 1 sends the request to the Content Licensor 106. However, those skilled in the art will readily appreciate that other embodiments can have the CSP sent the request to other entities, which function as the Licensor.

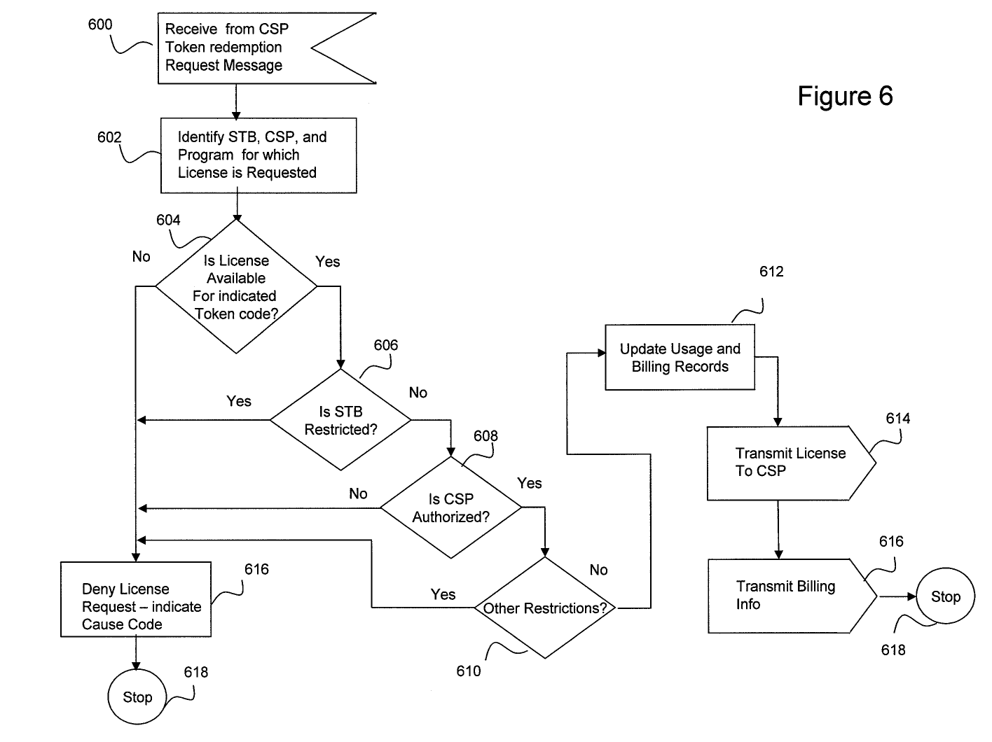

FIG. 6 illustrates the steps that typically occur by the Licensor during processing of the token code. At step 600, the Licensor receives the message from the CSP indicating either explicitly or implicitly that a token is being redeemed. The request must indicate the token code itself, and the request may also identify the program associated with the token code, or the Licensor may use the token code to ascertain the associated program. Thus, step 602 involves the Licensor parsing the message, and performing associated table lookups (if any) to ascertain the context of the requested transaction.

In step 604, the Licensor is now capable to evaluate the request. There is again a series of tests which may be performed by the Licensor to ascertain whether the request can be fulfilled. Further, these tests can vary in different embodiments. The test in step 604 is whether the token code can be fulfilled, based on the token code itself. For example, the token code may be associated with a non-existent promotional campaign, or one that has expired. The token code could have been mistyped by the viewer when entered, and represent an invalid code. The token could have been previously redeemed, and hence it can no longer be used. There are various reasons and various tests which step 604 can represent. If a license cannot be returned for whatever reason, the process continues to step 616 where the Licensor will respond to the CSP's request with a denial cause code indicating why the request could not be fulfilled.

If the license can be provided, the Licensor may then verify whether the STB making the request (assuming that the STB was identified in the initial request) is authorized in step 606. There may be ‘rogue’ STB boxes which represent stolen or cloned STBs that are recognized as such and for which requests should not be fulfilled. Further, the Licensor in step 608 may verify that the CSP is authorized to forward the request to the Licensor. Since the program promotion requires prior coordination with the CSP and other entities, the CSP forwarding the redemption request should be indicated by the Licensor as one of the participating CSPs. The CSP could be authorized, but for other reasons, the request may be denied. Similarly, if the request is denied for any reason, then the process in step 616 is executed.

Assuming that there are no reasons why the redemption request cannot be fulfilled, the Licensor then proceeds to step 612 where it updates its records. This step can occur at a various other points in the diagram shown. For example, records can be updated upon receipt of the request, and further updated upon fulfilling the request. Further, even requests that are not fulfilled typically result in logging aspects of the transaction. Thus, step 612 encompasses all the necessary logging and recording functions associated in the transaction by the Licensor, even thought they may occur at different points in time.

At step 614, the Licensor retrieves the appropriate license for the program, and transmits it the CSP. The response message may also include licensing or related restrictions, such as how many times the program can be viewed, time limits for storing the program, when the license expires, etc.

The next step, step 616 is related to how the Licensor is compensated, and is optional in various embodiments. If billing information is transmitted, it is typically transmitted in bulk at periodic intervals, and not after each time a license is provided to a CSP. Further, the entity to which the billing information is transmitted varies in each embodiment, as is discussed separately.

### Content Provider Operation

The Content Provider is typically involved only in a limited manner in the real time token redemption process. The Content Provider typically provides the program content to the appropriate CSP prior to the beginning of the promotion, or upon the initial request from the CSP. Once downloaded to the CSP, the CSP may cache the program for the duration of the promotion. In other embodiments it is possible for the Content Provider to download the program content for each request, but this may not be efficient if this occurs frequently.

The means for transporting the program itself may occur via a variety of technologies, including downloading via fiber, satellite links, or even via physical media, depending on the real-time requirements, security, and other aspects.

### Billing and Compensation

The concept of “billing” broadly refers to the accounting and payment of money associated with the above processes. The arrangements agreed to between the various entities can vary, but typically, there is compensation provided to at least some of the entities, and in particular, the CSP. In some cases, the compensation may be influenced by the number of subscriber's redeeming tokens with the CSP. As will be seen, there are various ways in which each entity can be compensated, and these are only illustrative embodiments.

The CSP provides the service delivering programs upon request to its subscribers who are redeeming tokens. In some cases the CSP may charge the subscriber for this. If so, then the CSP may share a portion of the revenue obtained from its subscribers with the Content Provider. In instances where the CSP does not charge the subscriber for performing this service, the CSP is typically still compensated for providing the service, and this typically may be from the Third Party Promoter, or the Content Provider. In many other embodiments, another entity may be coordinating and performing this function on behalf of the Content Provider or Third Party Promoter. Often, the compensation may be based on the number of subscribers which redeem tokens.

The Content Provider may compensate the Third Party Promoter for promoting the program, or in other cases, the Third Party Promoter may compensate the Content Provider. For example, in some cases the Content Provider may be promoting a program this is a high profile sequel, and the subject of great popular attention. A Third Party Promoter may pay the Content Provider for the exclusive rights to co-market their product along with the program. In other instances, the Third Party Promoter may function more as a traditional advertising agency promoting a program, to whom the Content Provider pays to promote the program. In this case, the Third Party Promoter may produce tokens which are not affiliated with any separate goods or services, but which solely function to promote the program.

As evident, there are various compensation arrangements, and often this will be tied to the number of individuals redeeming tokens with a given CSP. Consequently, maintaining an accurate accounting may be required, and each CSP may maintain a log of such redemptions. The Licensor may also maintain a record, and this could correlate with the requests received from the CSP for token redemption. As periodic intervals, or at the end of the promotion, these reports may be used as the basis for determining compensation due or auditing another entities claimed redemption level.

Further, the CSP or Licensor may use token redemption data to facilitate tracking which tokens were redeemed, where they were used, etc. From this data, the effectiveness of marketing campaigns from the Third Party Promoters can be assessed as well.

That which is claimed:

1. A system comprising:
a cable headend connected to a cable distribution network receiving a token code transmitted by a set top box connected to said cable distribution network wherein said token code is provided by a user to said set top box in order to receive a program comprising a digital video file for viewing by the user, said cable headend configured to:
receive and store the program at the cable headend,
determine the token code is a valid token code,
determine that the set top box is authorized to receive the program associated with the program code,
determine a licensing server to transmit the token code,
receive a decryption key and a control code from the licensing server, and
transmit the decryption key and the program to the set top box

2. The system of claim 1 wherein the cable headend is configured to transmit an applet to the set top box wherein the applet configures the set top box to prompt the user for the token code.

3. The system of claim 1 wherein the cable headend is configured to transmit the control code to the set top box wherein the control code indicates to the set top box how long the program is to be stored in the set top box.

4. The system of claim 1 wherein the cable headend comprises a database maintaining a usage file comprising a record storing the token code, a set top box identifier, and an indication that the program was transmitted to the set top box.

5. The system of claim 1 wherein the cable headend comprises a memory storing a table associating a token code value with a licensing server address.

6. The system of claim 1 wherein the cable headend comprises a database storing said program.

7. The system of claim of claim 6 wherein the cable headend is configured to determine whether the set top box is authorized to receive the program.

8. The system of claim 1 wherein the cable headend is configured to identify a content provider from which to request the program.

9. The system of claim 1 wherein the headend comprises a memory storing a plurality of token codes, including said token code.

10. A method for processing a token redemption request at a cable headend for viewing a program comprising a digital video program by a user on a cable network, comprising the steps of:
receiving a token code transmitted from a set top box wherein the set top box receives said token code entered by said user;
determining the token code is a valid token code;
determining that the set top box is authorized to receive said program;
determining a licensing server based on either the token redemption request or the token code;
transmitting the token code to the licensing server;
receiving a response from the licensing server wherein said response comprises a decryption key to decrypt the program and said response further comprising control data pertaining to usage of the decryption key or the program;
determining whether the program is locally stored in the cable headend;
retrieving the program from a content provider if the program is not locally stored;
transmitting the program to the set top box;
transmitting the decryption key to the set top box; and
recording a record in a usage file, said record comprising the token code, a set top box identifier, and an indication that the program was transmitted to the set top box.

11. The method of claim 10 further comprising the step of:
downloading an applet from the cable headend to the set top box wherein the applet provides a capability for the set top box to prompt the user for the token code.

12. The method of claim 11 wherein the control code indicates to the set top box how long the program is to be stored in the set top box.

13. The method of claim 10 wherein the control code indicates a date when the decryption key expires.

14. The method of claim 11 where the applet configures the STB to prompt the user to enter the token code comprising a numerical code using a handheld remote.

15. The method of claim 10 wherein a look up table stored in the cable headend is accessed using the token code to ascertain an address of the licensing server.

16. The method of claim 10 wherein the usage file is transmitted to a third party promoter

17. The method of claim 16 wherein the usage file is used to determine an amount of compensation to a CSP operating the cable headend.

18. The method of claim 10 wherein the cable service provider generates a bill for the user for receiving the program.

19. The method of claim 10 wherein the step of determining the token code is a valid token code comprises determining a date associated with the token code indicating the token code expires.

20. A method of providing a video program to a user:
downloading an application program to a set top box connected to a cable system wherein the application program prompts the user to enter a token code from a token, said token code allowing the user to receive a program;
receiving the token code at a processor located at a cable headend of the cable system, said token code conveyed by a cable network connected to both the cable headend and the set top box;
determining a set top box identifier associated with the set top box transmitting said token;
storing said token and said set top box identifier in a file;
determining by the processor that the set top box is authorized to redeem said token code;
determining by the processor an address of a licensing server to which the token code can be sent to;
transmitting the token code to the licensing server;
receiving at the processor a response from the licensing server wherein the response indicates a decryption key for decrypting the program and a control code pertaining to usage of the decryption key;
transmitting from the processor over the cable network to the application program in the set top box the decryption key and the control code;
retrieving by the processor the program and transmitting the program to the set top box; and
updating a file in a database by the processor by storing the token code, the set top box identifier, and a program identifier identifying the program.
